(19) United States
(12) Patent Application Publication
(10) Pub. No.: US 2007/0157956 A1
(43) Pub. Date: Jul. 12, 2007

(54) AUTOMATIC WASH WATER STORAGE APPARATUS FOR USE WITH PORTABLE WASH WATER SUPPLY HOSE

(76) Inventor: Byung Eun YOO, Daegu (KR)

Correspondence Address: CANTOR COLBURN, LLP, 55 GRIFFIN ROAD SOUTH, BLOOMFIELD, CT, 06002, US

(21) Appl. No.: 11/621,607

(22) Filed: Jan. 10, 2007

(30) Foreign Application Priority Data
Jan. 11, 2006 (KR) 2020060000832

(51) Int. Cl. B08B 3/04

(52) U.S. Cl. 134/104.4

(57) ABSTRACT

Disclosed herein is a wash water storage apparatus for exclusive use with a portable wash water supply hose that is used to remove feces contained for a long time in the human large intestine or wash the interior of the woman's vagina. The wash water storage apparatus can remove impurities contained in wash water to be supplied into the wash water supply hose and keep the wash water at a predetermined constant temperature. The apparatus includes an outer body including a cover and a temperature gauge panel having a power switch and temperature regulating switches, a filtering bucket inserted into the outer body and including a filter, and a supporting base mounted below the outer body and including a heater to come into contact with a lower surface of the filter for heating wash water having passed through the filtering bucket, a water level sensor and a water temperature sensor, and a drain passage to be connected to the wash water supply hose. In addition, a pump is connected to the drain passage by a connection tube and also connected to a transformer. A pumping tube is installed on the wash water supply hose to apply a pressure to an impeller, so as to turn on and off the impeller. Also, a sensor is provided in the supporting base and adapted to detect whether the impeller is turned on or off so as to regulate ON/OFF operations of the pump.

### BACKGROUND OF THE INVENTION

1. Field of the Invention

The present invention relates to a wash water storage apparatus for exclusive use with a portable wash water supply hose that is used to remove feces contained for a long time in the human large intestine or wash the interior of the woman's vagina, and more particularly, to an automatic wash water storage apparatus for use with a portable wash water supply hose, which can remove impurities contained in wash water to be supplied into the human intestine and the woman's vagina while keeping the wash water at a predetermined constant temperature, thereby supplying harmless wash water into a human body.

2. Description of the Related Art

As well known, the human large intestine has functions of not only regulating the content of moisture and maintaining a predetermined amount of electrolyte, but also solidifying ingesta into feces via bacterization. However, if the large intestine is not functioning properly, harmful ingredients and poisonous substances are accumulated in the human body, and thus, intestinal paralysis as well as expansion or rupture of aged blood vessels may be caused. As a result, the large intestine may be a hotbed of bacteria and various intestinal diseases such as constipation, diarrhea, indigestion, abdominal intumescence, large intestine cancer, colitis, irritable colon syndrome, ulcer of the large intestine, piles, lower abdominal inflation, loose feces, etc.

Accordingly, since accumulation of waste materials in the intestines causes intestinal paralysis, malfunction of the intestines, skin aging, and other various diseases, there is the urgent need for appropriate measures to eliminate the cause of the various intestinal diseases. For this reason, conventionally, intestinal washers have been used to remove the waste materials in the intestines and consequently prevent the various intestinal diseases. The conventional intestinal washers have been found to obtain outstanding effects in the removal of poisonous substances caused by feces contained for a long time in the large intestine, and therefore, are being widely used for the prevention and treatment of various intestinal diseases.

As an example of the conventional intestinal washers, Korean Utility Model Registration Nos. 338,146 and 342,570, which are registered by the applicant of the present invention, disclose portable washers having advantages of simple and convenient use with no cumbersome feeling when used. However, the disclosed portable washers have a problem in that a water container, in which wash water to be supplied into the washer is received, is connected to a wash liquid supply hose, and the water container has a poor outer appearance and also is undesirable in view of sanitation because it has no function of preventing invasion of impurities into the received wash water.

Furthermore, the disclosed container has a problem of inconvenience in use. In particular, it can be found that the water container included in the washer is unsuitable for use by disabled persons or old and weak persons.

### SUMMARY OF THE INVENTION

Therefore, the present invention has been made in view of the above problems, and it is an object of the present invention to provide an automatic wash water storage apparatus for exclusive use with a portable wash water supply hose used by a patient or woman for the washing of the large intestine or woman's vagina, which can remove impurities contained in wash water to be supplied into the wash water supply hose while appropriately regulating properties of the wash water, for example, a temperature of the wash water, and enable the automatic supply of wash water under the operation of a pump.

In accordance with the present invention, the above and other objects can be accomplished by the provision of an automatic wash water storage apparatus for supplying wash liquid, such as wash water, into a portable wash water supply hose that is usable to wash the interior of the woman's vagina or large intestine, the wash water storage apparatus comprising: an outer body including a cover configured to be pivotally rotated about a hinge shaft so as to selectively close an open top of the outer body, and grip recesses and a temperature gauge panel formed at a middle-height portion of the outer body, the temperature gauge panel having a power switch and temperature regulating switches; a filtering bucket inserted into the outer body and including a filter; and a supporting base mounted below the outer body and including a heater located to come into contact with a lower surface of the filter and adapted to heat wash water having passed through the filtering bucket, a water level sensor and a temperature sensor for detecting a level and a temperature of the wash water, and a drain passage to be connected to the wash water supply hose by means of a one-touch coupling, wherein a pump is connected to the drain passage of the supporting base by means of a connection tube, the pump also being connected to a transformer, a pumping tube is installed on the wash water supply hose and adapted to apply a pressure to an impeller provided in the supporting base, so as to turn on and off the impeller, and a sensor is provided in the supporting base and adapted to detect whether the impeller is turned on or off, so as to regulate ON/OFF operations of the pump.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a side sectional view of an automatic wash water storage apparatus according to the present invention, illustrating a filtering bucket lifted upward from the apparatus through an opened cover;

FIG. 2 is a sectional view taken along the line I-I of FIG. 1;

FIG. 3 is a plan view of the automatic wash water storage apparatus according to the present invention, from which the filtering bucket of FIG. 1 is omitted; and

FIGS. 4 and 5 are a plan view and a sectional view taken along the line II-II of FIG. 4, respectively, illustrating the use example of the present invention.

### DESCRIPTION OF THE PREFERRED EMBODIMENTS

Now, a preferred embodiment of the present invention will be explained in detail with reference to the accompanying drawings.

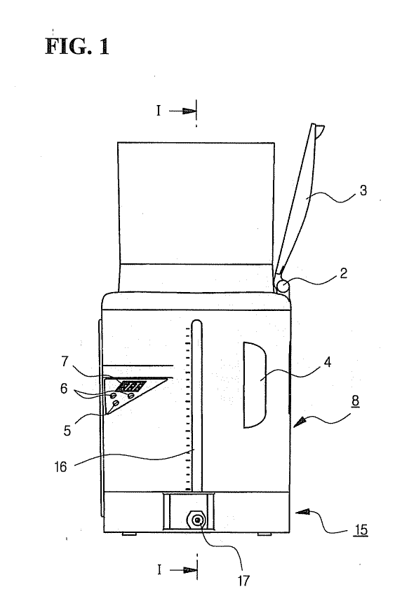

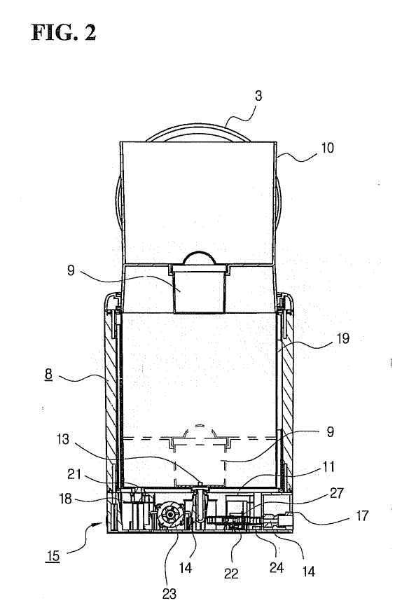

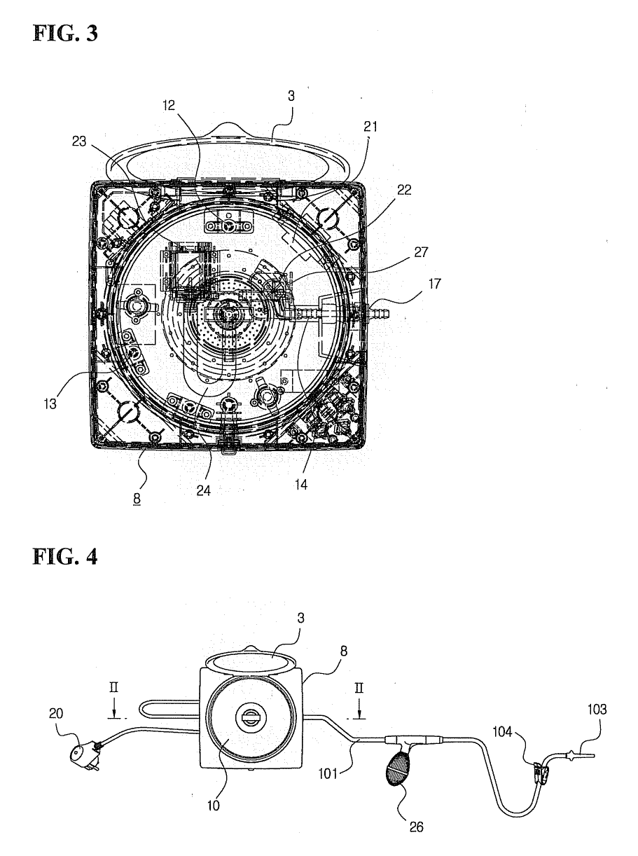

FIGS. 1 to 3 are a side view, a sectional view, and a plan view, respectively, illustrating an automatic wash water storage apparatus according to the present invention. Specifically, FIGS. 1 and 2 illustrate a filtering bucket included in the automatic wash water storage apparatus, whereas FIG. 3 omits the illustration of the filtering bucket.

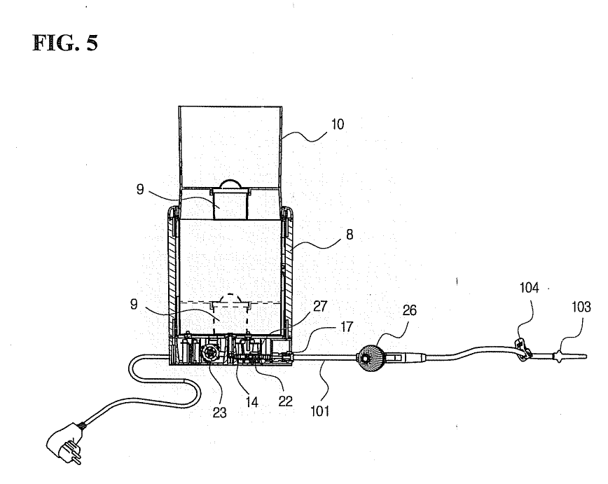

The wash water storage apparatus according to the present invention is used to supply wash liquid, i.e. wash water, into a portable wash water supply hose 101 (See FIG. 4) that is used to wash the interior of the woman's vagina or large intestine. The wash water storage apparatus basically includes an outer body 8, a filtering bucket 10, and a supporting base 15. Specifically, the outer body 8 includes a cover 1 configured to be pivotally rotated about a hinge shaft 2 so as to selectively close an open top of the outer body 8. The outer body 8 is formed, at the middle-height portion thereof, with a pair of grip recesses 4 and a temperature gauge panel 7 having a power switch 5 and temperature regulating switches 6. The filtering bucket 10 is separably inserted into the outer body 8 and has a filter 9 therein. The supporting base 15 is mounted below the outer body 3. The supporting base 15 includes a heater 11 installed to come into contact with a lower surface of the filter 9 and adapted to heat wash water having passed through the filtering bucket 10, a variety of sensors including a water level sensor 12 and a water temperature sensor 13 for detecting the level and temperature of the wash water, and a drain passage 14 having one end connected to the wash water supply hose 101 by means of a one-touch coupling 17. In the present invention, the drain passage 14 of the supporting base 15 is also connected, at the other end thereof, to a pump 23 by use of a connection tube 24 and in turn, the pump 23 is connected to a transformer 21. In addition, an impeller 22 is provided in the supporting base 15 and adapted to be turned on and off in response to a pressure applied by a pumping tube 26 that is installed on the wash water supply hose 101. Also, a sensor 27 is provided in the supporting base 15 near the impeller 22 and adapted to detect whether the impeller 22 is turned on or off, so as to generate a signal for turning on or off the pump 23.

Specifically, to allow a user to visually confirm the amount of wash water received in the filtering bucket 10 at real times in a state wherein the filtering bucket 10 is separably inserted into the outer body 8, the cover 3, which is adapted to be pivotally rotated to selectively close the open top of the outer body 8, is made of a transparent material, and the outer body 8 has a water level window 16. The one-touch coupling 17 is mounted to the end of the drain passage 14 received in the supporting base 15, so as to be connected to the wash water supply hose 101 that will be described hereinafter.

In addition, an overheating-prevention bimetal 18 is connected to the heater 11 received in the supporting base 15, and a body bucket 19 is mounted in the outer body 8. The body bucket 19 is plated with silver for the purpose of sterilizing harmful bacteria contained in the wash water having passed through the filter 9 of the filtering bucket 10.

With the above described configuration, wash water to be supplied into the known wash liquid supply hose 101 is primarily filtered by the filter 9 and secondarily, sterilized to remove harmful bacteria contained in the water by the body bucket 19 that is plated with silver that is 99.9% pure. Thereby, the filtered and sterilized wash water is able to be supplied to the wash water supply hose 101 in a state wherein it is kept at a predetermined constant temperature (approximately 38 degrees Celsius) optimal for the human body.

Here, the temperature of the wash water can be regulated by use of the temperature regulating switches 6 of the temperature gauge panel 7. The power switch 5 is an overall power ON/OFF switch.

The amount of wash water can be confirmed visually by use of the water level sensor 12 and the water level window 16. If no water is received in the wash water storage apparatus, the water level sensor 12 detects the absence of wash water and generates a signal for automatically turning off the heater 11.

The supporting base 15 containing the heater 11 is mounted below the outer body 8 and is made of a noncombustible material.

Now, the use of the present invention will be described with reference to FIGS. 4 and 5.

In use, first, the known wash water supply hose 101 is connected to the drain passage 14 of the supporting base 15 mounted below the outer body 8 by means of the one-touch coupling 17. Then, after connecting a power cord 20 of the wash water storage apparatus to an external power source, the power switch 5 is switched to turn on the wash water storage apparatus. In such a state, a temperature of the wash water being supplied from the filtering bucket 10 is able to be regulated to an appropriate value by use of the temperature regulating switches 6. If the temperature of the wash water reaches to the appropriate value, subsequently, the pump 23 is operated.

Next if the pumping tube 26 is pressed once in a state wherein a nozzle 103, which is provided at a distal end of the wash water supply hose 101, is inserted into the intestine or woman's vagina, the impeller 22 is turned off upon receiving a pressure applied from the pumping tube 26. In this case, if the sensor 27 detects no operation of the impeller 22 and sends a corresponding signal to the pump 23, the pump 23 is turned off in response to the signal from the sensor 27. If the pumping tube 26 is pressed again, the impeller 22 is turned on and consequently, the sensor 27 detects the operation of the impeller 22 and sends a corresponding signal to the pump 23, thus causing the pump 23 to be turned on. Thereby, the wash water, which was purified by passing through the filter 9 of the filtering bucket 10, is automatically supplied into the nozzle 103 through the drain passage 14 and the wash water supply pipe 101, so as to be supplied into the interior of the intestine or woman's vagina through the nozzle 103.

Here, a flow rate of the wash water being supplied through the wash water supply hose 101 is able to be regulated by use of a known flow rate regulator 104 that is installed on the wash water supply hose 101.

Meanwhile, when it is desired to stop the supply of wash water through the nozzle 103, the pumping tube 26 is pressed once as described above, so as to turn off the impeller 22. Thereby, as the sensor 27 detects no operation of the impeller 22 and sends a corresponding signal to the pump 23, the pump 23 is turned off and the supply of wash water is automatically stopped.

As apparent from the above description, the automatic wash water storage apparatus for use with the portable wash water supply hose according to the present invention can be used to filter and sterilize water, which will be used to wash the interior of the intestine or woman's vagina, while keeping the wash water at an appropriate constant temperature. The wash water storage apparatus according to the present invention has several advantages of an aesthetic outer appearance, expedient use, compact small size, and convenience in carrying and storage thereof as well as an outstanding functionality as a water storage apparatus for exclusive use with the portable wash water supply hose.

Furthermore, the wash water storage apparatus according to the present invention enables the automatic supply of wash water under the operation of a motor. Accordingly, the present invention allows the old and weak persons as well as patients to more conveniently and easily use the wash water storage apparatus.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An automatic wash water storage apparatus for supplying wash liquid, such as wash water, into a portable wash water supply hose that is usable to wash the interior of the woman's vagina or large intestine, the wash water storage apparatus comprising: an outer body including a cover configured to be pivotally rotated about a hinge shaft so as to selectively close an open top of the outer body, and grip recesses and a temperature gauge panel formed at a middle-height portion of the outer body, the temperature gauge panel having a power switch and temperature regulating switches; a filtering bucket inserted into the outer body and including a filter; and a supporting base mounted below the outer body and including a heater located to come into contact with a lower surface of the filter and adapted to heat wash water having passed through the filtering bucket, a water level sensor and a temperature sensor for detecting a level and a temperature of the wash water, and a drain passage to be connected to the wash water supply hose by means of a one-touch coupling, wherein
a pump is connected to the drain passage of the supporting base by means of a connection tube, the pump also being connected to a transformer,
a pumping tube is installed on the wash water supply hose and adapted to apply a pressure to an impeller provided in the supporting base, so as to turn on and off the impeller, and
a sensor is provided in the supporting base and adapted to detect whether the impeller is turned on or off, so as to regulate ON/OFF operations of the pump.
